(19) United States
(12) Patent Application Publication
(10) Pub. No.: US 2018/0267778 A1
(43) Pub. Date: Sep. 20, 2018

(54) SYSTEM AND METHOD FOR GRAPHICAL APPLICATION DEVELOPMENT

(71) Applicant: QUEUE SOFTWARE, INC., Raleigh, NC (US)

(72) Inventors: Aidan David CUNNIFFE, Raleigh, NC (US); Paul Joseph BERG, Raleigh, NC (US); Nathan Vincent FRECHETTE, Raleigh, NC (US)

(21) Appl. No.: 15/541,626

(22) PCT Filed: Jan. 4, 2016
(86) PCT No.: PCT/US2016/012059

§ 371 Date: Jul. 5, 2017

Related U.S. Application Data
(63) Continuation of application No. 14/589,679, filed on Jan. 5, 2015, now abandoned.

(51) Int. Cl. G06F 8/34; G06F 17/30

(52) U.S. Cl. CPC G06F 8/34; G06F 17/3056; G06F 17/30339

(57) ABSTRACT

A method, computer program product, and computing system for providing a plurality of program operations associated with a database table included within a computer database. The database table includes a plurality of data fields. A program operation is selected from the plurality of program operations, thus defining a chosen program operation. One or more graphical objects associated with the chosen program operation are provided. A graphical object is selected from the one or more graphical objects, thus defining a chosen graphical object. The chosen graphical object is linked to one of: an associated database operation performable within the computer database, or an associated data field chosen from the plurality of data fields included within the computer database.

### CROSS-REFERENCE TO RELATED APPLICATIONS

This application claims priority to and the benefit of U.S. Utility patent application Ser. No. 14/589,679, filed Jan. 5, 2015. The entire disclosure of which is incorporated herein by reference in its entirety.

### TECHNICAL FIELD

This disclosure relates to application development and, more particularly, to systems and methods for automated application development.

### BACKGROUND

The ability to quickly develop and bring to market application software is of paramount importance to the success of a software company. Accordingly, software development platforms have been developed that allow for the quasi-automated development of software applications. Examples of such platforms may include Visual C++ and Visual Basic platforms. Unfortunately, the availability of such development platforms is limited with respect to mobile application development.

### SUMMARY OF DISCLOSURE

In one implementation, a computer-implemented method includes providing a plurality of program operations associated with a database table included within a computer database. The database table includes a plurality of data fields. A program operation is selected from the plurality of program operations, thus defining a chosen program operation. One or more graphical objects associated with the chosen program operation are provided. A graphical object is selected from the one or more graphical objects, thus defining a chosen graphical object. The chosen graphical object is linked to one of: an associated database operation performable within the computer database, or an associated data field chosen from the plurality of data fields included within the computer database.

One or more of the following features may be included. The database table may be processed to generate the plurality of program operations associated with the database table. The chosen program operation may be named. The one or more graphical objects may include one of: a mandatory graphical object, or an optional graphical object. Linking the chosen graphical object may include generating/modifying a database schema associated with the computer database. Linking the chosen graphical object may include generating/modifying backend code associated with the computer database. Linking the chosen graphical object may include generating/modifying a native OS application associated with the computer database.

In another implementation, a computer program product resides on a computer readable medium that has a plurality of instructions stored on it. When executed by a processor, the instructions cause the processor to perform operations including providing a plurality of program operations associated with a database table included within a computer database. The database table includes a plurality of data fields. A program operation is selected from the plurality of program operations, thus defining a chosen program operation. One or more graphical objects associated with the chosen program operation are provided. A graphical object is selected from the one or more graphical objects, thus defining a chosen graphical object. The chosen graphical object is linked to one of: an associated database operation performable within the computer database, or an associated data field chosen from the plurality of data fields included within the computer database.

One or more of the following features may be included. The database table may be processed to generate the plurality of program operations associated with the database table. The chosen program operation may be named. The one or more graphical objects may include one of: a mandatory graphical object, or an optional graphical object. Linking the chosen graphical object may include generating/modifying a database schema associated with the computer database. Linking the chosen graphical object may include generating/modifying backend code associated with the computer database. Linking the chosen graphical object may include generating/modifying a native OS application associated with the computer database.

In another implementation, a computing system includes at least one processor and at least one memory architecture coupled with the at least one processor, wherein the computing system is configured to perform operations including providing a plurality of program operations associated with a database table included within a computer database. The database table includes a plurality of data fields. A program operation is selected from the plurality of program operations, thus defining a chosen program operation. One or more graphical objects associated with the chosen program operation are provided. A graphical object is selected from the one or more graphical objects, thus defining a chosen graphical object. The chosen graphical object is linked to one of: an associated database operation performable within the computer database, or an associated data field chosen from the plurality of data fields included within the computer database.

One or more of the following features may be included. The database table may be processed to generate the plurality of program operations associated with the database table. The chosen program operation may be named. The one or more graphical objects may include one of: a mandatory graphical object, or an optional graphical object. Linking the chosen graphical object may include generating/modifying a database schema associated with the computer database. Linking the chosen graphical object may include generating/modifying backend code associated with the computer database. Linking the chosen graphical object may include generating/modifying a native OS application associated with the computer database.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an graphical application development process coupled to a distributed computing network;

FIG. 2 is a diagrammatic view of a graphical user interface rendered by the graphical application development process of FIG. 1;

FIG. 3 is a flow chart of the graphical application development process of FIG. 1; and

FIG. 4 is another diagrammatic view of the graphical user interface rendered by the graphical application development process of FIG. 1.

Like reference symbols in the various drawings indicate like elements.

### DETAILED DESCRIPTION OF THE PREFERRED EMBODIMENTS

### System Overview:

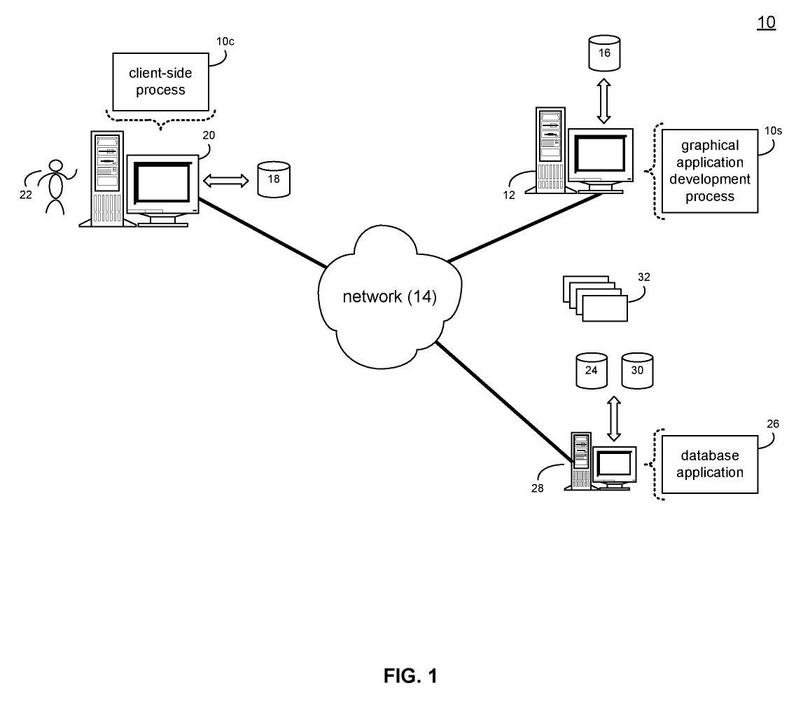

Referring to FIG. 1, there is shown graphical application development process 10. As will be discussed below in greater detail, graphical application development process 10 may be configured to develop software applications in a quasi-automated process.

Graphical application development process 10 may be implemented as a server-side process, a client-side process, or a hybrid server-side/client-side process. For example, graphical application development process 10 may be implemented as a purely server-side process via graphical application development process 10s. Alternatively, graphical application development process 10 may be implemented as a purely client-side process via client-side process 10c. Alternatively still, graphical application development process 10 may be implemented as a hybrid server-side/client-side process via graphical application development process 10s in combination with client-side process 10c. Accordingly, graphical application development process 10 as used in this disclosure may include any combination of graphical application development process 10s and client-side process 10c.

Graphical application development process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a dedicated network device.

The instruction sets and subroutines of graphical application development process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices. Any data generated, in whole or in part, by graphical application development process 10s may be stored on storage device 16 coupled to computing device 12.

Examples of client-side process 10c may include but are not limited to a web browser, a specialized desktop application, a game console user interface, or a specialized handheld application (e.g., an application running on e.g., the Android™ platform or the iPhone™ platform). The instruction sets and subroutines of client-side process 10c, which may be stored on storage devices 18 coupled to client electronic device 20, may be executed by one or more processors (not shown) and one or more memory architectures (not shown) incorporated into client electronic device 20. Examples of storage device 18 may include but are not limited to: hard disk drives; tape drives; optical drives; RAID devices; random access memories (RAM); read-only memories (ROM), and all forms of flash memory storage devices. Any data generated, in whole or in part, by client-side process 10c may be stored on storage device 18 coupled to client electronic device 20.

Examples of client electronic device 20 may include, but are not limited to personal computer 20, a data-enabled, cellular telephone (not shown), a laptop computer (not shown), a personal digital assistant (not shown), a tablet computer (not shown), a notebook computer (not shown), a server computer (not shown), a gaming console (not shown), a smart television (not shown), and a dedicated network device (not shown). Client electronic device 20 may execute an operating system, examples of which may include but are not limited to Microsoft Windows™, Android™, WebOS™, iOS™, Redhat Linux™, or a custom operating system.

User 22 may access graphical application development process 10 through network 14 via client-side process 10c/client electronic device 20. Alternatively, user 22 may access graphical application development process 10 directly through computing device 12.

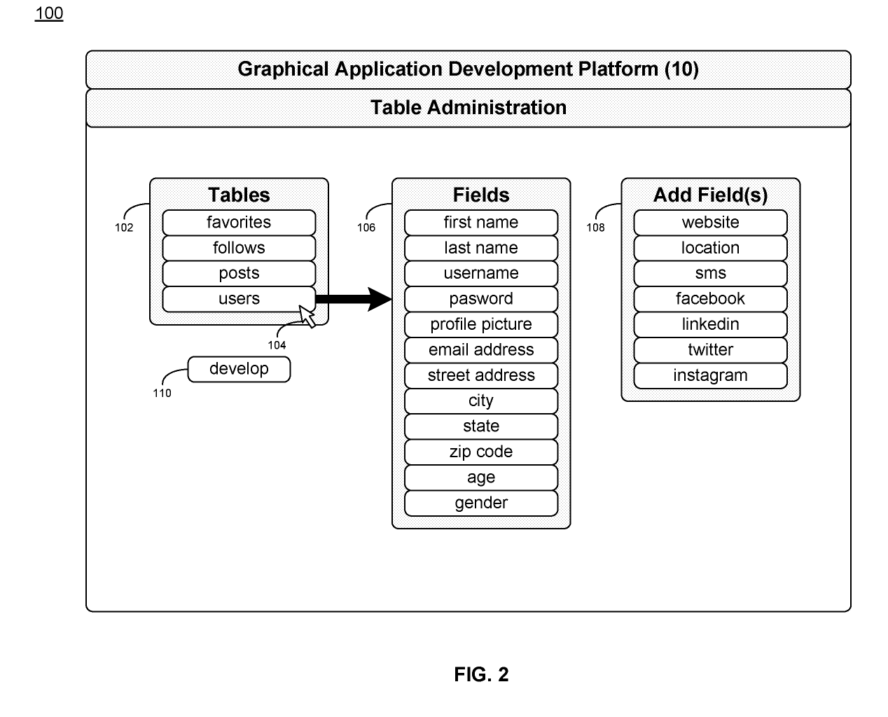

Referring also to FIG. 2, there is shown graphical user interface 100 rendered by graphical application development process 10. User interface 100 may be configured to allow a user (e.g., user 22) to design applications that interface with and access a database (e.g., database 24). Database 24 may be served by database application 26 that may be executed by computing device 28. Examples of database application 26 may include but are not limited to Oracle™, SQL Server™, DB2™, SyBase™, and MySQL™. Database 24 may be a database that user 22 is currently developing via graphical application development process 10. Alternatively, database 24 may be a preexisting database for which user 22 is developing an application via graphical application development process 10. Further still, database 24 may be a database that is owned/controlled by user 22 (e.g., user 22 is a software developer that is employed by the company that owns database 24). Or alternatively still, database 24 may be a database that is owned by a third party (e.g., user 22 is an independent software developer that is developing an application for the company that owns database 24. Examples of computing device 28 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a dedicated network device.

The instruction sets and subroutines of database application 26, which may be stored on storage device 30 coupled to computing device 28, may be executed by one or more processors (not shown) and one or more memory architectures (not shown) included within computing device 28. Examples of storage device 30 may include but are not limited to: a hard disk drive; a tape drive; an optical drive; a RAID device; a random access memory (RAM); a read-only memory (ROM); and all forms of flash memory storage devices.

As is known in the art, database 24 may allow a user (e.g., user 22) to define one or more tables (e.g., tables 32) within database 24, wherein each of these tables (e.g., tables 32) may include a plurality of data fields. For example, if the table (e.g., one of tables 32) within database 24 concerns the users of a particular website, examples of the fields within this “users” table may include but are not limited to: first name, last, name, username, password, profile picture, email address, street address, city, state, zip code, age and gender.

### Graphical Application Development Process:

As discussed above, graphical application development process 10 may be configured to develop applications in a quasi-automated process. Examples of these applications may include but are not limited to applications for mobile devices (e.g., smart phones and tablet computers) that allow access to database 24.

Assume for illustrative purposes that user 22 wishes to develop an iOS application that will run on an iPhone that will allow access to database 24. Accordingly and through the use of graphical user interface 100 rendered by graphical application development process 10, user 22 may review the tables (e.g., tables 32) included within database 24. Assume for illustrative purposes that database 24 includes four tables (as defined within table window 102 of graphical user interface 100), namely a “favorites” table, a “follows” table, a “posts” table and a “users” table. In the event that user 22 selects one of these tables (e.g., the “users” table) with e.g., onscreen pointer 104 controllable by a mouse (not shown), graphical application development process 10 may render field window 106 that identifies all of the fields included within the selected table (e.g., the “users” table). As discussed above, examples of the fields included within the “users” table may include but are not limited to: “first name”, “last name”, “username”, “password”, “profile picture”, “email address”, “street address”, “city”, “state”, “zip code”, “age” and “gender”. Graphical application development process 10 may further be configured to allow the user (e.g., user 22) to delete one or more of these fields and/or add additional fields to e.g., the “users” table via “add field(s)” window 108. Examples of the additional fields that may be added to the “users” table may include but are not limited to a “website field”, a “location field”, an “SMS field”, a “Facebook ID”™ field, a “LinkedIn ID”™ field, a “Twitter ID”™ field, and an “Instagram ID”™ field.

Continuing with the above stated example, assume that the user (e.g., user 22) selects the “users” table as the basis for their iOS application. Accordingly, user 22 may select “develop” button 110 using onscreen pointer 104.

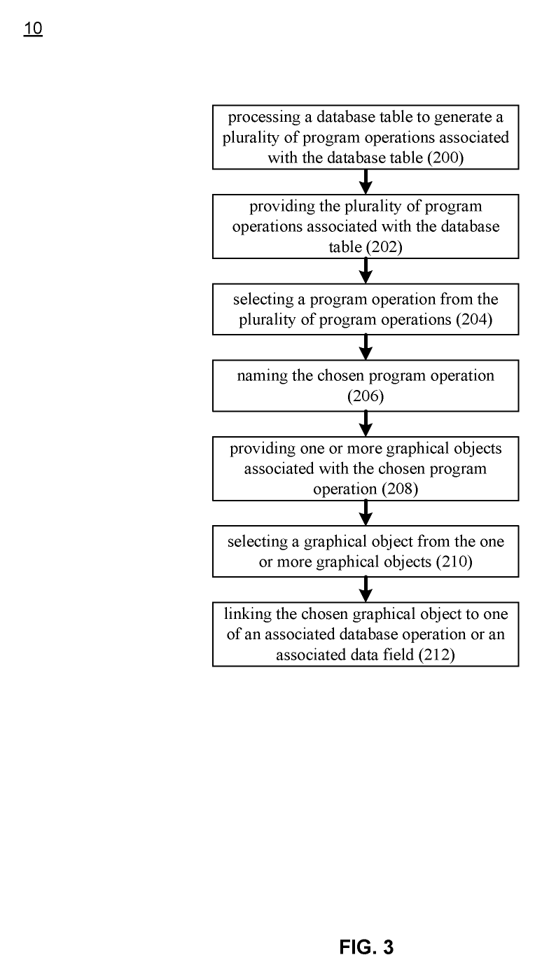

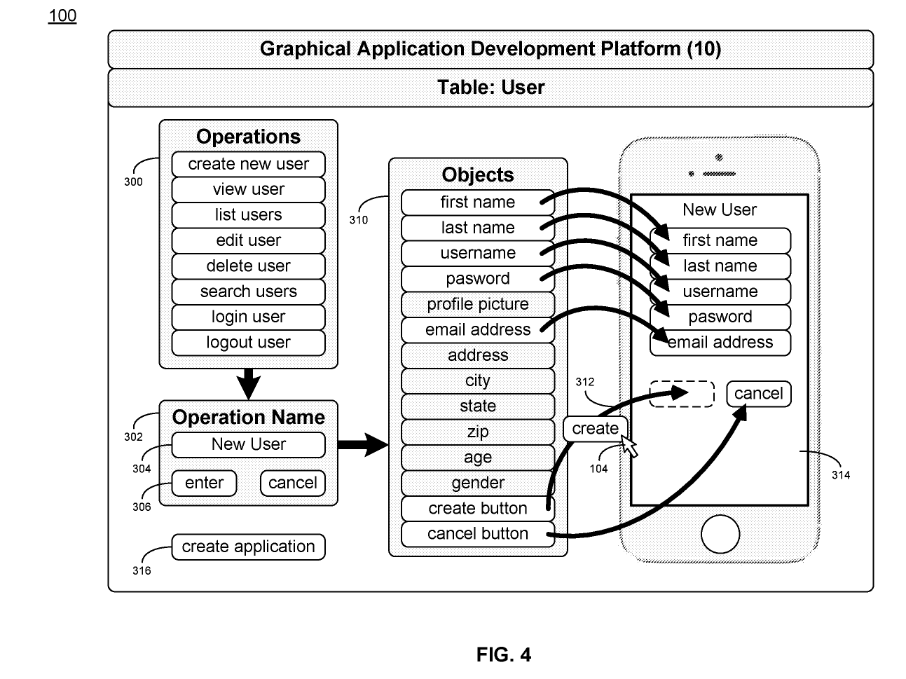

Once selected and referring also to FIGS. 3-4, graphical application development process 10 may process 200 the selected database table (e.g., the “users” table) to generate a plurality of program operations associated with the selected database table (e.g., the “users” table). Specifically, graphical application development process 10 may process 200 the selected database table (e.g., the “users” table) to determine the type of program operations (e.g., program operations 300) available for the selected table.

Once processed 200, graphical application development process 10 may provide 202 the plurality of program operations (e.g., within program operations window 300 of graphical user interface 100) that are associated with the database table (e.g., the “users” table) included within the computer database (e.g., database 24). In this particular example, the program operations provided 202 within program operations window 300 by graphical application development process 10 may include but are not limited to “create new user”, “view user”, “list users”, “edit user”, “delete user”, “search users”, “login user”, and “logout user”.

Graphical application development process 10 may allow user 22 to select 204 a program operation from the plurality of program operations (e.g., as defined within program operations window 300 of graphical user interface 100), thus defining a chosen program operation. Assume for illustrative purposes that user 22 selects “create new user” from the plurality of program operations defined within program operations window 300 of graphical user interface 100.

Once selected 204, graphical application development process 10 may be configured to allow user 22 to name 206 the chosen program operation (in this case, the “create new user” program operation). For example, graphical application development process 10 may render program operation naming window 302 that includes naming field 304. Within naming field 304, user 22 may enter a name for the “create new user” program operation selected 204 by user 22. Assume for illustrative purposes, that user 22 enters “new user” into naming field 304 and then selects enter button 306 using onscreen pointer 104.

Once selected 204 and named 206 (if required/desired), graphical application development process 10 may provide 208 one or more graphical objects associated with the chosen program operation (e.g., the “create new user” program operation).

When providing 208 the graphical objects, graphical application development process 10 may render object window 310 that may illustrate the one or more graphical objects associated with the chosen program operation (e.g., the “create new user” program operation). In this particular example, the graphical objects provided 208 within object window 310 by graphical application development process 10 may include but are not limited to: “first name”, “last name”, “username”, “password”, “profile picture”, “email address”, “street address”, “city”, “state”, “zip code”, “age”, “gender”, “create button” and “cancel button”.

The one or more graphical objects (as shown within object window 310) may include one or more mandatory graphical objects and/or one or more optional graphical object. Specifically, mandatory graphical objects may include those objects that are required by graphical application development process 10 to effectuate the selected 204 program operation (e.g., namely the “create new user” program operation). Conversely, optional graphical objects may include those objects that are not required by graphical application development process 10 to effectuate the selected 204 program operation (namely the “create new user” program operation).

In this particular example, “first name”, “last name”, “username”, “password”, “email address”, “create button” and “cancel button” are shown within object window 310 as mandatory graphical objects (i.e., not grayed), while “profile picture”, “street address”, “city”, “state”, “zip code”, “age” and “gender” are shown within object window 210 as optional graphical objects (i.e., grayed).

Graphical application development process 10 may allow user 22 to select 210 a graphical object from the one or more graphical objects (e.g., as provided 208 within object window 310 by graphical application development process 10), thus defining a chosen graphical object. Once a graphical object is selected 210, graphical application development process 10 may link 212 the chosen graphical object to one of: a) an associated database operation performable within the computer database (e.g., database 24) or b) an associated data field chosen from the plurality of data fields included within the computer database (e.g., database 24).

For example and using onscreen pointer 104, graphical application development process 10 may allow user 22 to select 210 a graphical object from the one or more graphical objects (e.g., as provided 208 within object window 210 by graphical application development process 10) by e.g., clicking on it and dragging it (as illustrated by drag line 312) to the desired position within design space 314, as rendered by graphical application development process 10. As discussed above and in this particular example, the application being developed is an iOS application that will run on an iPhone and be used to access database 24. Accordingly, design space 314 may be configured by graphical application development process 10 to resemble an iPhone, thus allowing user 22 to properly (and visually) position the selected 210 graphical objects within design space 314.

Assume for illustrative purposes that user 22 only selects 210 and positions the mandatory graphical objects, namely “first name”, “last name”, “username”, “password”, “email address”, “create button” and “cancel button” within design space 314, as rendered by graphical application development process 10.

As discussed above, once a graphical object is selected 210, graphical application development process 10 may link 212 the chosen graphical object to one of: a) an associated database operation performable within the computer database (e.g., database 24) or b) an associated data field chosen from the plurality of data fields included within the computer database (e.g., database 24).

For example, the graphical objects that are associated with data fields within database 24 (e.g., namely “first name”, “last name”, “username”, “password”, and “email address”) are linked 212 to the corresponding data fields within database 24), where the graphical objects that are associated with database operations performable with database 24 (e.g., namely “create button” and “cancel button”) are linked 212 to these associated database operations performable with database 24. Accordingly and through the use of graphical application development process 10, user 22 may develop (in this example) an application that allows a handheld electronic device (e.g., an iPhone) to access a database (e.g., database 24) by simply dragging and dropping design elements (e.g., the various graphical objects) onto a visual representation of a design space (e.g., design space 314) associated with the handheld electronic device. And when graphically positioning these graphical objects within design space 314, the above-described linking operation automatically occurs (i.e., without requiring the user to e.g., define the database, define the database table, identify the related data field, define the database operation, manually configure the API(s), manually write database code, manually write application code, etc.).

When linking 212 the chosen graphical object, graphical application development process 10 may generate/modify a database schema associated with the computer database (e.g., database 24). While is the above-described example, graphical application development process 10 is described as being utilized with an established database, other configurations are possible and are considered to be within the scope of this disclosure. For example and when the database is being developed, when generating/modifying the database schema associated with database 24, graphical application development process 10 may be configured to modify/generate one or more portions of database 24 based, at least in part, upon any graphical options selected by the user (e.g., user 22).

Further, when linking 212 the chosen graphical object, graphical application development process 10 may generate/modify backend code associated with the computer database (e.g., database 24). Specifically, when generating/modifying the backend code associated with database 24, graphical application development process 10 may be configured to send the information gathered to computing device 12 (which may or may not be cloud based). Graphical application development process 10 may then e.g., loop through all the various program operations specified by the user (e.g., user 22) and may generate a RESTful API route for each one. These RESTful API routes may then be packaged into a web service and deployed on servers with a publically accessible IP address for application testing, production and deployment.

Additionally, when linking 212 the chosen graphical object, graphical application development process 10 may generate/modify a native OS application associated with the computer database (e.g., database 24). Specifically, when generating/modifying the native OS application associated with database 24, graphical application development process 10 may be configured to send the information gathered about e.g., the application layout, application style, application data connections, and application structures to computing device 12 (which may or may not be cloud based). Graphical application development process 10 may then loop through all of the pages in the application being developed and may generate e.g., XML that defines the layout of each application page (included within the application). Each application page (and some of the more complicated elements within these pages) may get their own class generated with all the available methods and functionality written into them. Information about the RESTful API routes discussed above may then be used to generate requests to the above-described web services. When executed in running applications, the parameters sent to the web service may include the values of the forms generated on the user interface. Any response from the web service may be parsed and displayed on the interface in accordance with the links specified by the user (e.g., user 22).

Once user 22 has completed the design of the application (e.g., an iOS application for an iPhone), graphical application development process 10 may be configured to allow user 22 to select “create application” button 316 (with onscreen point 104), thus resulting in the compilation and finalization of e.g., the iOS iPhone application.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
providing a plurality of program operations associated with a database table included within a computer database, wherein the database table includes a plurality of data fields;
selecting a program operation from the plurality of program operations, thus defining a chosen program operation;
providing one or more graphical objects associated with the chosen program operation;
selecting a graphical object from the one or more graphical objects, thus defining a chosen graphical object; and
linking the chosen graphical object to one of:
an associated database operation performable within the computer database, or
an associated data field chosen from the plurality of data fields included within the computer database.

2. The computer-implemented method of claim 1 further comprising:
processing the database table to generate the plurality of program operations associated with the database table.

3. The computer-implemented method of claim 1 further comprising:
naming the chosen program operation.

4. The computer-implemented method of claim 1 wherein the one or more graphical objects includes one of: a mandatory graphical object, or an optional graphical object.

5. The computer-implemented method of claim 1 wherein linking the chosen graphical object includes generating/modifying a database schema associated with the computer database.

6. The computer-implemented method of claim 1 wherein linking the chosen graphical object includes generating/modifying backend code associated with the computer database.

7. The computer-implemented method of claim 1 wherein linking the chosen graphical object includes generating/modifying a native OS application associated with the computer database.

8. A computer program product residing on a computer readable medium having a plurality of instructions stored thereon which, when executed by a processor, cause the processor to perform operations comprising:
providing a plurality of program operations associated with a database table included within a computer database, wherein the database table includes a plurality of data fields;
selecting a program operation from the plurality of program operations, thus defining a chosen program operation;
providing one or more graphical objects associated with the chosen program operation;
selecting a graphical object from the one or more graphical objects, thus defining a chosen graphical object; and
linking the chosen graphical object to one of:
an associated database operation performable within the computer database, or
an associated data field chosen from the plurality of data fields included within the computer database.

9. The computer program product of claim 8 further comprising instructions for:
processing the database table to generate the plurality of program operations associated with the database table.

10. The computer program product of claim 8 further comprising instructions for:
naming the chosen program operation.

11. The computer program product of claim 8 wherein the one or more graphical objects includes one of: a mandatory graphical object, or an optional graphical object.

12. The computer program product of claim 8 wherein the instructions for linking the chosen graphical object include instructions for generating/modifying a database schema associated with the computer database.

13. The computer program product of claim 8 wherein the instructions for linking the chosen graphical object include instructions for generating/modifying backend code associated with the computer database.

14. The computer program product of claim 8 wherein the instructions for linking the chosen graphical object include instructions for generating/modifying a native OS application associated with the computer database.

15. A computing system including a processor and memory configured to perform operations comprising:
providing a plurality of program operations associated with a database table included within a computer database, wherein the database table includes a plurality of data fields;
selecting a program operation from the plurality of program operations, thus defining a chosen program operation;
providing one or more graphical objects associated with the chosen program operation;
selecting a graphical object from the one or more graphical objects, thus defining a chosen graphical object; and
linking the chosen graphical object to one of:
an associated database operation performable within the computer database, or
an associated data field chosen from the plurality of data fields included within the computer database.

16. The computing system of claim 15 further configured to perform operations comprising:
processing the database table to generate the plurality of program operations associated with the database table.

17. The computing system of claim 15 further configured to perform operations comprising:
naming the chosen program operation.

18. The computing system of claim 15 wherein the one or more graphical objects includes one of: a mandatory graphical object, or an optional graphical object.

19. The computing system of claim 15 wherein linking the chosen graphical object includes generating/modifying a database schema associated with the computer database.

20. The computing system of claim 15 wherein linking the chosen graphical object includes generating/modifying backend code associated with the computer database.

21. The computing system of claim 15 wherein linking the chosen graphical object includes generating/modifying a native OS application associated with the computer database.
